(19) United States
(12) Patent Application Publication
(10) Pub. No.: US 2020/0255294 A1
(43) Pub. Date: Aug. 13, 2020

(54) FLUIDIC EXFOLIATION

(71) Applicant: Imperial College Innovations Limited, London (GB)

(72) Inventors: Jason Stafford, London (GB); Omar Matar, London (GB); Camille Petit, London (GB)

(21) Appl. No.: 16/635,538

(22) PCT Filed: Jul. 31, 2018
(86) PCT No.: PCT/GB2018/052182

§ 371 Date: Jan. 30, 2020

(30) Foreign Application Priority Data
Jul. 31, 2017 (GB) 1712306.8

(51) Int. Cl. C01B 32/19; B01J 19/18; B01J 19/00

(52) U.S. Cl. CPC C01B 32/19; B01J 19/1806; B01J 19/0066; C01P 2002/82; B01J 19/0013; B01J 2219/00033; C01P 2004/04; B01J 19/1843

(57) ABSTRACT

The invention provides an apparatus for fluidic exfoliation of a layered material comprising: a housing of circular cross-section defined by a housing wall; a hollow rotor of circular cross-section having a first end and a second end and a wall positioned therebetween arranged concentrically within the housing, wherein the wall of the hollow rotor defines an inner chamber and the space in between the wall of the hollow rotor and the housing wall defines an outer chamber, and wherein a fluid flow path is provided between the inner chamber and the outer chamber; a fluid inlet in fluid communication with the inner chamber or the outer chamber; and a fluid outlet in fluid communication with the other of the inner chamber or the outer chamber; wherein the outer chamber has a width such that on passage of a fluid comprising the layered material from the inlet to the outlet through the outer chamber, a shear rate sufficient to exfoliate the layered material may be applied to the fluid comprising the layered material in the outer chamber by rotation of the hollow rotor.

### FIELD

The present invention relates to an apparatus for fluid exfoliation of a layered material (such as graphite) and processes for fluidic exfoliation of a layered material using said apparatus.

### BACKGROUND

Atomically thin, two-dimensional (2D) monolayer materials have demonstrated remarkable properties in numerous research studies over the past decade. The most widely studied 2D material is graphene, with intrinsic mobilities in excess of 200,000 cm²v⁻¹s⁻¹, Young's modulus of about 1 TPa, optical transmittance of about 97.7%, and thermal conductivity of about 5000 W m⁻¹ K⁻¹, respectively. These unique material characteristics suggest that graphene has the potential to provide revolutionary advances in applications such as opto-electronics, semiconductors, biomedical sensors, tissue engineering, drug delivery, energy conversion and storage. Other monolayer materials such as monolayers of hexagonal boron nitride (h-BN), molybdenum disulfide (MoS₂), molybdenum trioxide (MoO₃), gallium telluride (GaTe) or bismuth selenide (Bi₂Se₃) have also shown promise in similar areas. These applications are within three broad sectors that have the biggest impact on society: information communication technology (ICT), biomedicine and energy. It is, therefore, imperative that these exciting materials can be exploited on a large scale to address the global challenges that society faces.

Fundamental research in the field of 2D materials has grown rapidly, and new materials with unique properties and novel applications are being discovered continuously. Despite these efforts, the widespread introduction of 2D materials into real technologies that benefit society are limited. The main challenge attributed to this, as outlined by various recent reviews (E. P. Randviir et al., Materials Today, 17.9 (2014), 426-432 and A. C. Ferrari et al., Nanoscale, 7 (2015), 4598-4810, the contents of which are herein incorporated by reference in their entirety), is the development of suitable processes for scale-up and mass production. Growth and exfoliation are the two main avenues to produce 2D materials. Liquid exfoliation methods have been described as exhibiting either high production rates or low defects and show promise for scale-up (K. R. Paton et al., Nature Materials, 13 (2014), 624-630, the contents of which are herein incorporated by reference in their entirety). Sonication, chemical and electrochemical are the most common methods for liquid exfoliation that have been used at a laboratory scale. A study published in 2014 on scalable production of graphene using a shear-mixing batch exfoliation approach in liquids demonstrated yields of less than 3% (K. R. Paton et al., Nature Materials, 13 (2014), 624-630). In a large-scale trial, just 21 g of high quality graphene with Raman D/G ratio of 0.18 was produced from a 300 L mixture of graphite (21 kg) and N-Methyl-2-pyrrolidone (NMP) solvent. The production rate for this trial was the highest reported in the literature to date at 5.3 g h⁻¹. Although process scaling was achieved, yield and production rate remain extremely low for economical manufacturing or widespread use.

There is a fundamental limitation with existing shear-exfoliation approaches due to the batch processing characteristic. The raw material is a mixture of the layered material to be exfoliated (e.g., graphite particles), and a liquid for stabilising and preventing re-aggregation of the nanosheets. Existing exfoliation methods are designed for laboratory scale. However, it is inefficient when processing at a large scale. In typical batch ultrasonic exfoliation, the amount of energy per unit volume of, for example, a liquid-graphite mixture is of order 10¹⁰ J m⁻³ to maintain yields of 0.1%. Each individual step in the process is segregated and solutions must be passed from one stage to the next in a discontinuous manner. This increases processing time and the risk of exposure to potentially harmful solvents (such as NMP). The state-of-the-art also suffers from scale-up effects. The spatial distribution of shear stress within existing batch exfoliation designs is non-uniform and the velocity fields are highly chaotic, leading to poor repeatability in product output. Hence, designing scaled-up systems is challenging, as the fluid mechanics and local shear rate distributions change with dimensions of the container.

Accordingly, there remains a need to provide an efficient, cost-effective and scalable process for the production of 2D monolayer materials at any scale.

### SUMMARY OF INVENTION

The present invention addresses the limitations associated with the state-of-the-art providing an efficient, cost-effective and scalable means for production of 2D materials by exfoliation of 3D layered materials at any scale.

In a first aspect, the invention provides an apparatus for fluidic exfoliation of a layered material comprising:
a housing of circular cross-section defined by a housing wall;
a hollow rotor of circular cross-section having a first end and a second end and a wall positioned therebetween arranged concentrically within the housing, wherein the wall of the hollow rotor defines an inner chamber and the space between the wall of the hollow rotor and the housing wall defines an outer chamber, and wherein a fluid flow path is provided between the inner chamber and the outer chamber;
a fluid inlet in fluid communication with the inner chamber or the outer chamber; and
a fluid outlet in fluid communication with the other of the inner chamber or the outer chamber;
wherein the outer chamber has a width such that on passage of a fluid comprising the layered material from the inlet to the outlet through the outer chamber, a shear rate sufficient to exfoliate the layered material may be applied to the fluid comprising the layered material in the outer chamber by rotation of the hollow rotor.

The following features discussed in relation to the apparatus of the invention apply mutatis mutandis to all other aspects of the invention, including the use and processes described below.

Fluid flow through the apparatus may be such that the fluid flows from the fluid inlet to the inner chamber, from the inner chamber via the fluid flow path to the outer chamber and from the outer chamber to the fluid outlet. Alternatively, flow may be reversed and fluid flow through the apparatus may be such that the fluid flows from the fluid inlet to the outer chamber, from the outer chamber via the fluid flow path to the inner chamber and from the inner chamber to the fluid outlet

It will be appreciated that the shear rate that may be applied to the fluid in the outer chamber may depend on the width of the outer chamber, the radius of the hollow rotor and the speed of rotation of the rotor. The shear rate can be tuned to the rate required by adjusting the width of the outer chamber, the radius of the hollow rotor and/or the speed of rotation depending on the requirements of the user. The apparatus of the invention is, therefore, not limited to any specific dimensions as any combination of dimensions and rotation speeds may be tuned to provide shear rate sufficient to exfoliate the layered material. The outer chamber width may, for example, not exceed about 10 cm, about 5 cm, about 2 cm, about 1 cm or about 0.5 cm.

As would be appreciated by a skilled person, it is the rotating action of the rotor relative to the housing (for example, rotating relative to a fixed housing, rotating a speed greater than the housing or rotating in an opposite direction to the housing) that provides a shear rate to the layered material during operation of the apparatus. The shear rate generated may be at rate sufficient to exfoliate the layered material. For example, the shear rate may be generated at a rate greater than about 1000 s⁻¹, preferably about 1500 s⁻¹, preferably about 2000 s⁻¹, preferably about 5000 s⁻¹, preferably about 10000 s⁻¹. The shear rate sufficient to exfoliate the layered material may be applied to the fluid at any point within the outer chamber. Shear rate may be calculated as described herein.

Preferably, the flow of the fluid through the apparatus during operation of the apparatus is such that Taylor vortices occur. For example, the Reynolds number may be less than about 20000, preferably less than about 15000. The Reynolds number is preferably greater than about 95. The Taylor number is preferably greater than the critical Taylor value (Ta_{c}). The Reynolds and Taylor numbers may be calculated as described herein.

Preferably, the internal surfaces of the apparatus (e.g., the internal surface of the housing wall and the surfaces of the rotor) may be substantially smooth.

The apparatus may be for continuous fluidic exfoliation of a layered material.

The housing may comprise a first end and a second end, with the housing wall provided therebetween, arranged in the same orientation as the first and second end of the rotor. The apparatus may further comprise a base at the second end of the housing. As would be appreciated by a skilled person, during operation of the apparatus, the apparatus is sealed at the second end of the housing. The seal at the second end of the housing may form part of the housing.

The fluid inlet and fluid outlet may both be positioned at or adjacent to the second end of the rotor. During operation of the apparatus, the second end of the rotor is arranged towards the base of the apparatus. As a result, the fluid comprising the layered material is introduced into the apparatus from the base, against gravity. This reduces build-up of layered material that could lead to a flow blockage.

The fluid inlet may be in fluid communication with the inner chamber and the fluid outlet may be in fluid communication with the outer chamber. Alternatively, the fluid inlet may be in fluid communication with the outer chamber and the fluid outlet may be in fluid communication with the inner chamber

The fluid flow path may be provided between the inner chamber and the outer chamber between the fluid inlet and the fluid outlet, preferably at or adjacent to the first end of the rotor. Preferably, the fluid flow path is provided within about 25% of the length of the rotor from the first end of the rotor preferably within about 10%. Thus, during operation of the apparatus, the fluid is introduced at the base of the apparatus and flows against gravity through the inner or outer chamber before passing through the fluid flow path towards the top of the apparatus and flowing out of the outlet at the base of the apparatus. Preferably, the fluid flows across substantially the full length of the rotor (in both the inner and outer chamber).

The fluid flow path between the inner chamber and the outer chamber may be provided through the first end of the rotor or through the wall of the rotor adjacent to the first end of the rotor.

The housing may be provided in a fixed position. Alternatively, the housing may be rotatable. If the housing is rotatable, to ensure a shear rate is generated in the outer chamber, in operation, the housing should rotate at a slower speed than the rotor or rotate in the opposite direction (i.e., if the rotor rotates clockwise, the housing should rotate clockwise slower than the rotor or the housing should rotate anticlockwise).

The apparatus may further comprise a motor configured to provide a rotational force to rotate the rotor. It will be appreciated that the speed of rotation can be varied to control the shear rate applied to the layered material during operation of the apparatus. For example, the motor may be configured to rotate the rotor at a speed of at least about 2000 r.p.m., preferably at least about 3000 r.p.m., preferably at least about 4000 r.p.m., preferably at least about 5000 r.p.m., preferably at least about 6000 r.p.m., preferably at least about 7000 r.p.m., preferably at least about 8000 r.p.m.

It will also be appreciated by a skilled person, that the width of the outer chamber can be varied to control the shear rate applied to the layered material during operation of the apparatus. For example, the outer chamber may have a width not exceeding about 9 mm, preferably about 8 mm, preferably about 7 mm, preferably about 6 mm, preferably about 5 mm, preferably about 4 mm, preferably about 3 mm, preferably about 2 mm. The outer chamber may have a width of at least 0.1 mm, preferably at least 0.5 mm. The outer chamber may have a width of about 0.1 mm to about 1 cm, preferably about 0.5 to about 5 mm.

The rotor may be cylindrical in shape. The housing wall may be cylindrical such that the housing and the cylindrical rotor may be arranged as concentric cylinders. Accordingly, the outer chamber may have a constant width throughout the apparatus.

Alternatively, the housing may have a conical shape such that the housing as an increasing or a decreasing width as the height of the housing varies. In such cases, the cylindrical rotor is arranged such that the cross-section of the housing and the cross-section of the cylindrical rotor are concentric circles. Accordingly, the outer chamber may have a varying width at different heights of the housing.

The rotor may be conical in shape such that the rotor cross-section has an increasing or a decreasing radius as the height of the rotor varies. The housing wall may be cylindrical. In such cases, the rotor is arranged such that the cross-section of the housing and the cross-section of the rotor are concentric circles. Accordingly, the outer chamber may have a varying width at different heights of the housing. Alternatively, the housing may have a conical shape such that the housing cross-section has an increasing or a decreasing radius as the height of the housing varies. In such cases, the rotor is arranged such that the cross-section of the housing and the cross-section of the rotor are concentric circles.

The apparatus may further comprise a pump arranged to drive a fluid comprising the layered material through the apparatus. It will be appreciated that the pump can operate to drive fluid flow at any speed during operation of the apparatus. Varying speed of fluid flow controls residency time of the fluid comprising the layered material in the apparatus and, thus, the extent of shear applied to the layered material. For example, flow speeds of from about 1 ml min⁻¹ to about 1000 ml min⁻¹ could be used. The fluid flow speed may be constant or varied (for example, pulsed).

The apparatus may further comprise a fluid reservoir in fluid communication with the fluid inlet for holding a fluid comprising the layered material for providing the fluid to the inlet during operation of the apparatus.

The apparatus may further comprise a source of heat to heat a fluid comprising the layered material passing through the apparatus. The heat source may be provided externally to the apparatus, for example in the form of a heating mat that may be wrapped around the housing. Alternatively, the heat source may be provided within the apparatus as an integral heat source, for example a heating element provided within the fluid flow channel within the apparatus.

The fluid may comprise particles of the layered material. The fluid may comprise up to about 15 wt % of the layered material calculated as a total weight of the fluid and layered material, preferably about 0.1 to about 15 wt % , preferably about 1 to about 10 wt %, preferably about 5 wt %.

The layered material may be graphite, boron nitride (BN), gallium telluride (GaTe), bismuth selenide (Bi₂Se₃), bismuth telluride (Bi₂Te₃), antimony telluride (Sb₂Te₃), titanium nitride chloride (TiNCl), black phosphorus, layered silicates, layered double hydroxides (such as Mg₆Al₂(OH)₁₆) or a transition metal chalcogenide having the formula MXₙ, wherein M is a transition metal, X is a chalcogen and n is 1 to 3, or a combination thereof. M may be selected from the group comprising Ti, Zr, Hf, V, Nb, Ta, Cr, Mn, Mo, W, Tc, Re, Ni, Pd, Pt, Fe and Ru; and X may be selected from the group comprising O, S, Se, and Te. Exemplary metal chalcogenides include molybdenum disulfide (MoS₂) and molybdenum trioxide (MoO₃). Further layered materials that may be used in the present invention are disclosed in V. Nicolosi et al., Science, 340 (2013), 1420, the contents of which are herein incorporated by reference in their entirety. Preferably the layered material is graphite.

The fluid may be an organic solvent. Exemplary organic solvents include N-methyl pyrrolidone (NMP), cyclohexylpyrrolidone, di-methyl formamide, cyclopentanone (CPO), cyclohexanone, N-formyl piperidine (NFP), vinyl pyrrolidone (NVP), 1,3-dimethyl-2-imidazolidinone (DMEU), bromobenzene, benzonitrile, N-methyl-pyrrolidone (NMP), benzyl benzoate, N,N′-dimethylpropylene urea, (DMPU), gamma-butrylactone (GBL), Dimethylformamide (DMF), N-ethyl-pyrrolidone (NEP), dimethylacetamide (DMA), cyclohexylpyrrolidone (CHP), dimethyl sulfoxide (DMSO), dibenzyl ether, chloroform, isopropylalcohol (IPA), cholobenzene, l-octyl-2-pyrrolidone (N8P), 1-3 dioxolane, ethyl acetate, quinoline, benzaldehyde, ethanolamine, diethyl phthalate, N-dodecyl-2-pyrrolidone (N12P), pyridine, dimethyl phthalate, formamide, vinyl acetate or acetone or a combination thereof. Preferably the organic solvent is NMP.

The fluid may further comprise a polymer, for example selected from polyvinyl alcohol (PVA), polybutadiene (PBD), poly(styrene-co-butadiene) (PBS), polystyrene (PS), polyvinylchloride (PVC), polyvinylacetate (PVAc), polycarbonate (PC), polymethylmethacrylate (PMMA), polyvinylidene chloride (PVDC) and cellulose acetate (CA).

The fluid may further comprise a surfactant, for example selected from the group comprising sodium cholate (NaC), sodium dodecylsulphate (SDS), sodium dodecylbenzenesulphonate (SDBS), lithium dodecyl sulphate (LDS), sodium cholate (SC), sodium deoxycholate (DOC), sodium taurodeoxycholate (TDOC), polyoxyethylene (40) nonylphenyl ether, branched (IGEPAL CO-890® (IGP)), polyethylene glycol p-(1,1,3,3-tetramethylbutyl)-phenyl ether (Triton-X 100® (TX-100)), cetyltrimethyl ammoniumbromide (CTAB), tetradecyltrimethylammonium bromide (TTAB), Tween™ 20 and Tween™ 80. Further surfactants that may be used in the present invention are disclosed in R. J. Smith et al., New Journal of Physics, 12 (2010), 125008, the contents of which are herein incorporated by reference in their entirety.

Advantageously, the layered material is directly exfoliated into a matrix material to form a composite. This avoids intermediate processing steps such as extraction of the layered material from the solvent and incorporation of the layered material into a matrix material. Graphene, for example has a short settling time and direct exfoliation into a matrix material allows the direct production and thus, use of the composition material without additional processing step. Accordingly, the fluid may therefore be a suitable matrix material such as a printable ink composition or a polymer or copolymer, for example selected from a thermoplastic, a thermoset, an elastomer or a biopolymer or a combination thereof. The wt % concentration of the layered material in the fluid will result in a composite material having the same wt % concentration of exfoliated material.

It will be appreciated that to ensure suitable flow properties for the matrix material to enable its use as the fluid, a heat source as described herein may need to be provided with the apparatus.

In another aspect, the invention provides the use of the apparatus as described herein in the fluidic exfoliation of a layered material as described herein. The fluidic exfoliation may be carried out by rotating the rotor as described herein to apply a shear rate to the layered material.

In another aspect, the invention provides a process for fluidic exfoliation of a layered material as described herein using an apparatus as described herein, comprising:
introducing a fluid comprising a layered material through the fluid inlet; and
applying a shear rate to the layered material by rotating the rotor at a speed sufficient to exfoliate the layered material.

In another aspect, the invention provides a process for fluidic exfoliation of a layered material as described herein using an apparatus as described herein, comprising:
introducing a fluid comprising a layered material through the fluid inlet;
passing the fluid into the inner chamber;
passing the fluid through the fluid flow path to the outer chamber; and
passing the fluid from the outer chamber to the fluid outlet;
wherein the rotor is rotating at a speed sufficient to apply shear rate to exfoliate the layered material.

In another aspect, the invention provides a for fluidic exfoliation of a layered material as described herein using an apparatus as described herein, comprising:
introducing a fluid comprising a layered material through the fluid inlet;
passing the fluid into the outer chamber;
passing the fluid from the outer chamber through the fluid flow path to the inner chamber; and
passing the fluid from the inner chamber to the fluid outlet;
wherein the rotor is rotating at a speed sufficient to apply a shear rate to exfoliate the layered material.

As would be appreciated, the features discussed in relation to the apparatus of the invention apply mutatis mutandis to the following discussion of the process, which makes use of the apparatus of the invention. Moreover, the following features discussed in relation to the process of the invention apply mutatis mutandis to all other aspects of the invention.

It will be appreciated that, as discussed herein, the speed of rotation of the rotor necessary to generate a shear rate sufficient to exfoliate the layered material will depend on the dimensions of the apparatus. Thus, the process may be tuned to meet the requirements of the user. For example, the rotor may be rotating at a speed of at least about 1000 r.p.m., preferably at least about 2000 r.p.m., preferably at least about 3000 r.p.m., preferably at least about 4000 r.p.m., preferably at least about 5000 r.p.m., preferably at least about 6000 r.p.m., preferably at least about 7000 r.p.m., preferably at least about 8000 r.p.m.

The shear rate applied to the layered material may be at a rate greater than about 1000 s⁻¹, preferably about 1500 s⁻¹, preferably about 2000 s⁻¹, preferably about 5000 s⁻¹, preferably about 10000 s⁻¹.

Advantageously, the processes of the invention may be continuous processes. Unlike batch processes known in the art, a continuous flow of the fluid comprising the layered material may be passed through the apparatus. This avoids the need to empty the apparatus and replace with a new unexfoliated batch of the fluid as unexfoliated fluid is continuously being introduced into the apparatus.

The fluid may be passed through the apparatus by a pump as described herein.

The process may further comprise the heating the fluid comprising the layered material while the fluid is in the apparatus and/or prior to introducing the fluid into the apparatus.

The fluid may comprise particles of the layered material. The fluid may comprise up to about 15 wt % of the layered material calculated as a total weight of the fluid and layered material, preferably about 0.1 to about 15 wt %, preferably about 1 to about 10 wt %, preferably about 5 wt %.

The layered material may be graphite, boron nitride (BN), gallium telluride (GaTe), bismuth selenide (Bi₂Se₃), bismuth telluride (Bi₂Te₃), antimony telluride (Sb₂Te₃), titanium nitride chloride (TiNCI), black phosphorus, layered silicates, layered double hydroxides (such as Mg₆Al₂(OH)₁₆) or a transition metal chalcogenide having the formula MXₙ, wherein M is a transition metal, X is a chalcogen and n is 1 to 3, or a combination thereof. M may be selected from the group comprising Ti, Zr, Hf, V, Nb, Ta, Cr, Mn, Mo, W, Tc, Re, Ni, Pd, Pt, Fe and Ru; and X may be selected from the group comprising O, S, Se, and Te. Exemplary metal chalcogenides include molybdenum disulfide (MoS₂) and molybdenum trioxide (MoO₃). Further layered materials that may be used in the present invention are disclosed in V. Nicolosi et al., Science, 340 (2013), 1420. Preferably the layered material is graphite.

The fluid may be an organic solvent. Exemplary organic solvents include N-methyl pyrrolidone (NMP), cyclohexylpyrrolidone, di-methyl formamide, cyclopentanone (CPO), cyclohexanone, N-formyl piperidine (NFP), vinyl pyrrolidone (NVP), 1,3-dimethyl-2-imidazolidinone (DMEU), bromobenzene, benzonitrile, N-methyl-pyrrolidone (NMP), benzyl benzoate, N,N′-dimethylpropylene urea, (DMPU), gamma-butrylactone (GBL), Dimethylformamide (DMF), N-ethyl-pyrrolidone (NEP), dimethylacetamide (DMA), cyclohexylpyrrolidone (CHP), dimethyl sulfoxide (DMSO), dibenzyl ether, chloroform, isopropylalcohol (IPA), cholobenzene, l-octyl-2-pyrrolidone (N8P), 1-3 dioxolane, ethyl acetate, quinoline, benzaldehyde, ethanolamine, diethyl phthalate, N-dodecyl-2-pyrrolidone (N12P), pyridine, dimethyl phthalate, formamide, vinyl acetate or acetone or a combination thereof. Preferably the organic solvent is NMP.

The fluid may further comprise a polymer, for example selected from polyvinyl alcohol (PVA), polybutadiene (PBD), poly(styrene-co-butadiene) (PBS), polystyrene (PS), polyvinylchloride (PVC), polyvinylacetate (PVAc), polycarbonate (PC), polymethylmethacrylate (PMMA), polyvinylidene chloride (PVDC) and cellulose acetate (CA).

The fluid may further comprise a surfactant, for example selected from the group comprising sodium cholate (NaC), sodium dodecylsulphate (SDS), sodium dodecylbenzenesulphonate (SDBS), lithium dodecyl sulphate (LDS), sodium cholate (SC), sodium deoxycholate (DOC), sodium taurodeoxycholate (TDOC), polyoxyethylene (40) nonylphenyl ether, branched (IGEPAL CO-890® (IGP)), polyethylene glycol p-(1,1,3,3-tetramethylbutyl)-phenyl ether (Triton-X 100® (TX-100)), cetyltrimethyl ammoniumbromide (CTAB), tetradecyltrimethylammonium bromide (TTAB), Tween™ 20 and Tween™ 80. Further surfactants that may be used in the present invention are disclosed in R. J. Smith et al., New Journal of Physics 12 (2010) 125008.

The process may further comprise the step of removing the exfoliated layered material from the fluid, optionally by low-speed centrifugation, gravity settling, filtration or flow separation. The process may further comprise the step of placing the exfoliated layered material into a matrix to form a composite. The matrix may be a printable ink composition or a polymer or copolymer, for example selected from a thermoplastic, a thermoset, an elastomer or a biopolymer or a combination thereof.

Advantageously, the layered material is directly exfoliated into a matrix material to form a composite. This avoids intermediate processing steps such as extraction of the layered material from the solvent and incorporation of the layered material into a matrix material. Graphene, for example has a short settling time and direct exfoliation into a matrix material allows the direct production and thus, use of the composition material without additional processing step. Accordingly, the fluid may therefore be a suitable matrix material such as a printable ink composition or a polymer or copolymer, for example selected from a thermoplastic, a thermoset, an elastomer or a biopolymer or a combination thereof. It will be appreciated that to ensure suitable flow properties for the polymer to enable its use as the fluid, the process may further comprise heating the fluid using a heat source as described herein.

In another aspect, there is provided a 2-dimensional exfoliated layered material produced by a process as described herein. For example, the material may be graphene.

In another aspect, there is provided a device comprising exfoliated layered material produced by the process described above. For example, the device may be a thin film of the 2D exfoliated material (such as graphene) on a substrate, or the device may be a component coated by the 2D exfoliated material (such as graphene). The device may be selected from, but not limited to, the group comprising electrodes, transparent electrodes, capacitors, transistors, solar cells, dye sensitised solar cells, light emitting diodes, thermoelectric devices, dielectrics, batteries, battery electrodes, capacitor, super capacitors, sensors (for example, chemical and biological sensors), nano-transistors, nano-capacitors, nano-light emitting diodes, and nano-solar cells.

In another aspect, the invention provides an apparatus, process or use as substantially described herein with reference to or as illustrated in one or more of the example or accompanying figures.

### BRIEF SUMMARY OF FIGURES

FIG. 1 shows an apparatus for fluidic exfoliation of a layered material.

FIG. 2 shows Transmission Electron Microscopy images of exfoliated graphene.

FIG. 3 shows a section of an apparatus illustrating the housing, the rotor and the outer chamber.

FIG. 4 shows an apparatus for direct fluidic exfoliation of a layered material into a matrix comprising a heat source.

FIG. 5 shows an apparatus for fluidic exfoliation of a layered material highlighting the inner and outer chambers (numbering corresponds to the numbering of FIG. 1).

FIG. 6 shows graphene concentration over a fluidic exfoliation processing time of 10 hours.

FIG. 7 shows the production rate of graphene over a fluidic exfoliation processing time of 10 hours.

FIG. 8 shows the average number of layers over time for the graphene produced in FIG. 6.

FIG. 9 shows the Raman shift for a fluidic exfoliated graphene product.

FIG. 10 shows a Transmission Electron Microscopy image of an exfoliated graphene nanosheet produced from a fluidic exfoliation process.

### DETAILED DESCRIPTION

The invention provides an apparatus for continuous fluidic exfoliation of a layered material comprising:
a housing of circular cross-section defined by a housing wall;
a hollow rotor of circular cross-section having a first end and a second end and a wall positioned therebetween arranged concentrically within the housing, wherein the wall of the hollow rotor defines an inner chamber and the space between the wall of the hollow rotor and the housing wall defines an outer chamber, and wherein a fluid flow path is provided between the inner chamber and the outer chamber;
a fluid inlet in fluid communication with the inner chamber or the outer chamber; and
a fluid outlet in fluid communication with the other of the inner chamber or the outer chamber;
wherein the outer chamber has a width such that on passage of a fluid comprising the layered material from the inlet to the outlet through the outer chamber, a shear rate sufficient to exfoliate the layered material may be applied to the fluid comprising the layered material in the outer chamber by rotation of the hollow rotor.

The rotation of the hollow rotor relative to the housing simultaneously creates two fluidic zones. The first fluidic zone is in the inner chamber within the hollow rotor. An axially centred vortex provides the initial (stage 1) mixing and shearing of the fluid comprising the layered material. An external pump may be used to drive this fluid through the fluid flow path towards the top of the inner chamber at a user-specified flow rate. The fluid leaves the inner chamber and enters the outer chamber between the wall of the rotor and the housing wall. This annular gap is the second fluidic zone. The motion of the rotating rotor, relative to the housing, generates higher mixing and shearing forces (stage 2). Circumferential vortices, known as Taylor vortices, are generated within this fluid gap when the Taylor number exceeds a certain critical value (Ta>Ta_{c}) that depends on the width of the outer chamber, the radius of housing and the relative rotational speed of the rotor (Ta and Ta_{c} may be calculated using the Equation 8, where Ta_{c} is the Taylor number when the Reynolds number is at the critical value of about 95). Particles of the layered material to be exfoliated are transported along the streamlines of these well-controlled vortices. The result is homogeneous mixing and shearing of the layered material. The flow rate of the pump can be adjusted independently to the exfoliator rotational speed. Hence, the residence time of a particle of the layered material can be set to anything from seconds to infinite time (i.e., pump at zero flow rate).

Of course, as would be appreciated by a skilled person, the flow may be reversed and the fluid may pass through the outer chamber before the inner chamber during operation of the device.

The Taylor number of system may exceed a critical value that depends on the width of the outer chamber, the radius of housing and the relative rotational speed of the rotor. For example, the shear rate applied to the layered material during operation of the device may be at a rate greater than about 1000 s⁻¹. Preferably, the shear rate may be greater than about 10000 s⁻¹. The maximum shear rate is preferably applied to the layered material in the outer chamber. For example, where the layered material is graphene, a shear rate of \dot{γ}ₜₐₘ˜1×10⁴ s⁻¹ in the outer chamber may be applied.

Where the rotor and housing are cylindrical, the radius ratio between the outer radius of the inner cylindrical rotor (η) and the housing radius (rₒ) (i.e., the outer chamber) is:

$$η = \frac{{r}_{i}}{{r}_{o}} \qquad ( 1 )$$

The shear rate in a laminar Taylor-Couette flow is

$${\dot{γ}}_{lam} = r ( \frac{d {Ω}_{lam}}{dr} ) ,$$

where Ωₜₐₘ=u₇₄ /r is the angular laminar azimuthal velocity, r is the radius and u₇₄ is the laminar azimuthal velocity. When η approaches unity, this shear rate can be estimated for a inner cylindrical rotor with stationary outer cylindrical housing by:

$${\dot{γ}}_{lam} \approx \frac{{r}_{i} {ω}_{i}}{d} \qquad ( 2 )$$

The shear rate defined above scales with three parameters: ˜rᵢ, ˜d and ˜ωᵢ, the outer radius of the inner cylindrical rotor, the outer chamber width and the cylindrical rotor relative rotational speed respectively. As would be appreciated by a skilled person, it can, therefore, be increased by increasing the rotor radius, rotor rotational speed (where housing is fixed), and/or decreasing the outer chamber width. The apparatus will be a trade-off between all three parameters. For example, using a gap of 2 mm and inner cylindrical rotor radius of 50 mm, a rotational speed of 3820 r.p.m. may be required to achieve a shear rate of at least 1000 s⁻¹. Increasing the gap to 3 mm and a speed of 5730 r.p.m. may be necessary to achieve a shear rate of at least 1000 s⁻¹. Millimeter scale outer chamber widths have been considered and found to work best, as this prevented blockages of the precursor. For example, the outer chamber may have a width of less than about 1 cm.

The above shear rate calculation is for laminar flow. If the apparatus is operated in a transitional or turbulent flow regime, additional stresses within the fluid may be generated by the formation of fluid structures, such as eddies. This may increase the shearing on the layered material. Thus, the laminar equations described herein may be used to calculate the minimum shear rate that the apparatus may generate. The Reynolds number may be used to determine the flow regime of the apparatus (Equation 7).

Where the outer chamber has variable width (for example, if the housing is conical shaped and the rotor is cylindrical), the average outer chamber width may be used to determine the average shear rate. The minimum outer chamber width may be used to determine the maximum shear rate and the maximum outer chamber width may be used to determine the minimum shear rate.

Inner Chamber (Stage 1)—Reynolds Numbers

The cylindrical rotor defines the inner chamber. The outer radius of the rotor has been defined as rᵢ above. The internal radius of this cylindrical rotor (i.e., the radius of the inner chamber), is defined herein as rᵢᵢ. This radius also impacts the initial, Stage 1 mixing/shearing. The level of mixing within the inner chamber depends on the rotating Reynolds number:

$$R {e}_{r} = \frac{{ω}_{i} {D}_{i i}^{2}}{2 v} \qquad ( 3 )$$

where Dᵢᵢ=2rᵢᵢ and v is the kinematic viscosity of the fluid. Kinematic viscosity may be determined using, for example, a glass capillary kinematic viscometer. Standard methods for determining kinematic viscosity are set out in ASTM D445-17a (Standard Test

Method for Kinematic Viscosity of Transparent and Opaque Liquids) and ASTM D446-12 (Standard Specifications and Operating Instructions for Glass Capillary Kinematic Viscometers). For example, kinematic viscosity may be determined by measuring the time for a volume of fluid to flow under gravity through a calibrated glass capillary viscometer. The kinematic viscosity is the product of the measured flow time and the calibration constant of the viscometer. Viscometers shall be mounted in the constant temperature bath in the same manner as when calibrated and stated on the certificate of calibration of the viscometer.

When the pump is set at zero flow rate, the transport phenomena (heat/mass) scales with this Reynolds number to an exponent that depends on the flow regime (laminar/turbulent) such that ˜Reᵣ^{b}, where b is the exponent typically 0.5-1.0 (see A. Bejan, Convection Heat Transfer, (2004) 3^{rd} Ed., Wiley). When the pump continuously delivers fluid into the device, an additional axial Reynolds number is necessary to correlate the influence of a continuous flow on transport phenomena in the inner chamber (˜Re_{a,1}^{b}):

$$R {e}_{a , 1} = \frac{4 \dot{Q}}{π {D}_{i i} v} \qquad ( 4 )$$

where \dot{Q} is the volumetric flow rate delivered by the pump.

Outer Chamber (Stage 2)—Reynolds and Taylor Numbers

Another consideration is providing a production approach which is inherently repeatable. Although turbulent flows provide additional stresses that enhance exfoliation, the stochastic nature of high levels of turbulence may have an adverse effect on production repeatability to an extent. It is preferable, therefore, to exfoliate layered materials at reasonably low Reynolds numbers, where the fluid motion is inherently repeatable (i.e. laminar). For example, the Reynolds number may less than about 2×10⁴. These flow regimes can be described using the relationship for Reynolds number in a Taylor-Couette flow arrangement:

$$R e = \frac{2}{1 + η} \vert η {R}_{o} - {R}_{i} \vert \qquad ( 5 )$$

where Rᵢ and Rₒ are the inner and outer chamber Reynolds numbers:

$${R}_{i} = \frac{{r}_{i} {ω}_{i} d}{v} ; {R}_{o} = \frac{{r}_{o} {ω}_{o} d}{v} \qquad ( 6 )$$

The apparatus preferably has a stationary cylindrical housing (ωₒ=0). This reduces the general Reynolds number definition, Re, to:

$$R e = \frac{2}{1 + η} {R}_{i} \qquad ( 7 )$$

Taylor vortices exist due to inertial instabilities that occur beyond a critical condition. These vortices are useful for mixing the fluid, ensuring that particles of the layered material experience a similar shear (integrated over time). The occurrence of these vortices is defined by the Taylor number:

$$T a = 4 R {e}^{2} ( \frac{1 - η}{1 + η} ) \qquad ( 8 )$$

Equations (7) and (8) describe the rotational parameters for the outer chamber. When a fluid is continuously passed through the device, the axial Reynolds number is described as:

$$R {e}_{a , 2} = \frac{2 \dot{Q}}{π {r}_{i} ( 1 + \frac{1}{η} ) v} \qquad ( 9 )$$

where \dot{Q} is the volumetric flow rate delivered by the pump.

It is worth noting that Stage 1 & Stage 2 mixing/exfoliation regions are coupled, when comparing the equations 2-4 & 7-9. For example, increasing rotational speed will increase shear rates and Reynolds numbers in both the inner hollow cylindrical rotor and fluid gap between inner rotor and outer housing. Conversely, decreasing speed decreases the shearing/mixing intensity.

Outer Chamber (Stage 2)—Dimensionless Torque

When using the apparatus with a range of different fluids, or entirely new fluids, it can be challenging to predict the flow regime within the device (i.e. laminar/transitional/turbulent). This flow regime, however, can be determined by monitoring the torque characteristics of the device. The dimensionless torque describes this:

$$G = \frac{T}{ρ H {v}^{2}} \qquad ( 10 )$$

where T is the torque, and H is the height of the outer chamber between the housing wall and the rotor wall. The dimensionless torque scales with radius ratio (equation 1) and Reynolds number (equation 5). This scaling depends on the flow regime of the device. Three torque regimes have been classified for a system with rotating inner cylindrical rotor and a stationary cylindrical housing, and include: laminar, transitional, ‘soft turbulence’ and ‘hard turbulence’. For laminar flow (Re<Re_{c}):

$${G}_{i} = {G}_{lam} = \frac{2 π}{{( 1 - η )}^{2}} η R e \qquad ( 11 )$$

As Reynolds number increases beyond a critical point (Re_{c}≈95), where viscosity can no longer dampen instabilities in a supercritical case, Taylor vortices occur. This has been shown to occur at Re≈95 (see D. P. Lathrop et al., Physical Review A, 46 (1992), 6930).

There is a change in the torque scaling for this regime (Re_{c}≤Re≤Re_{T}):

$${G}_{i} = \frac{{( 3 + η )}^{1 / 4} η R {e}^{3 / 2}}{{( 1 - η )}^{7 / 4} {( 1 + η )}^{1 / 2}} \qquad ( 12 )$$

Within this regime, the onset of ‘soft turbulence’ may occur at Re≈1.5×10⁴. Finally, another transitional point in torque scaling has been observed at larger Reynolds numbers (Re>Re_{T}). This ‘hard turbulence’ transitional point has been associated with a featureless turbulence regime and occurs beyond Re˜10⁵. The apparatus is preferably not intended to operate in this regime, however, the inclusion of inner cylindrical rotor roughness/microscale geometric features could lead to this featureless effect at lower Re than the classical case. Dimensionless torque in a ‘hard turbulence’ regime and rough walls is:

$${G}_{i} = 0.107 \frac{\sqrt{3 + η}}{( 1 + η ) {( 1 - η )}^{3 / 2}} {( η R e )}^{2} \qquad ( 13 )$$

The dimensionless torque in a ‘hard turbulence’ regime and smooth walls is:

$$\begin{matrix}{G}_{i} = 0.33 \frac{\sqrt{3 + η}}{( 1 + η ) {( 1 - η )}^{3 / 2}} \frac{{( η R e )}^{2}}{{( ln [ ( M ( η ) {( η R e )}^{2} ) ] )}^{3 / 2}} & ( 14 ) \\ where \\ M ( η ) = 0.0001 \frac{( 1 - η ) ( 3 + η )}{{( 1 + η )}^{2}} & ( 15 )\end{matrix}$$

Flows transitioning to turbulence can be observed when

$$\frac{{G}_{i}}{{G}_{la m}} ≫ 1.$$

Outer Chamber (Stage 2)—Shear Rate for Exfoliation

When using the apparatus with a range of different fluids, or entirely new fluids, the flow regime (i.e. laminar/transitional/turbulent) influences the shear rate that is generated by the device. This shear rate can be determined using the relationship between wall shear stress and dimensionless torque. The shear rate in the outer chamber is:

$$\dot{γ} = \frac{{G}_{i} v}{2 π {r}_{o}^{2}} \qquad ( 16 )$$

where the selection of Gᵢ (Equations 11-15) is dependent on the operating Reynolds number for the device (Equation 7).

Properties of Fluids Used in Exfoliation

The equations that describe the fluid motion within the device have been outlined above. Viscosity and density fluid properties are included in these expressions. By adjusting the parameters in the equations above, the device can be operated to provide the necessary shear rate conditions and flow regimes with any working fluid. This results in a broad/robust approach. Fluids particularly suited to exfoliation and long-term dispersion have been previously defined as having a surface tension which is close to that of the material being exfoliated (see Y. Hernandez et al., Langmuir, 26 (2010), 3208-3213, the contents of which are herein incorporated by reference in their entirety).

In the apparatus, use or process of the invention, the fluid may comprise particles of the layered material. The fluid may comprise up to about 15 wt % of the layered material calculated as a total weight of the fluid and layered material, preferably about 0.1 to about 15 wt %, preferably about 1 to about 10 wt %, preferably about 5 wt %.

As used herein, particles may have an average maximum dimension of less than about 500 μm, preferably less than about 400 μm, preferably less than about 300 μm, preferably less than about 200 μm, preferably less than about 150 μm. It would be appreciated by a skilled person that depending on morphology of the particulate material, the average maximum dimension may be an average diameter or, for example in the case of platelets, an average lateral dimension. It would also be appreciated by a skilled person that, depending on the type of particle, the average diameter may be determined by any of the methods described herein.

Particles may be provided in the form of platelets or flakes (used interchangeably) of the layered material. The flakes may have an average thickness of for example up to about 10 μm, preferably about 100 nm. The flakes may have an average lateral dimension (maximum diameter) of up to about 1000 μm, preferably about 500 μm. The average lateral dimension and average thickness is the arithmetic mean of the lateral dimension and thickness, respectively. The lateral dimensions of the layered material flakes may be measured using optical and/or scanning electron microscopy. The thickness may be determined using atomic force microscopy or transmission electron microscopy.

Alternatively, particles may be provided as a powder, for example having an average particle diameter of about 1 to about 500 μm. As used herein, average particle diameter refers to the modal value of a particle diameter distribution, for example the modal intensity count value of a distribution of particle diameters measured by dynamic light scattering (DLS) using a light scattering detector, for example that of a Zetasizer™ pV instrument (Malvern, UK). Intensity counts are the first order output for samples measured by dynamic light scattering (DLS) using a light scattering detector. For example, particle diameters may be determined by diluting a dispersed particle sample in an aqueous solvent sufficiently to allow DLS to be applied, using a Zetasizer™ pV instrument (Malvern, UK). Other methods such as laser diffraction or sedimentation may alternatively be used.

The layered material may be graphite, boron nitride (BN), gallium telluride (GaTe), bismuth selenide (Bi₂Se₃), bismuth telluride (Bi₂Te₃), antimony telluride (Sb₂Te₃), titanium nitride chloride (TiNCI), black phosphorus, layered silicates, layered double hydroxides (such as Mg₆Al₂(OH)₁₆) or a transition metal chalcogenide having the formula MXₙ, wherein M is a transition metal, X is a chalcogen and n is 1 to 3, or a combination thereof. M may be selected from the group comprising Ti, Zr, Hf, V, Nb, Ta, Cr, Mn, Mo, W, Tc, Re, Ni, Pd, Pt, Fe and Ru; and X may be selected from the group comprising O, S, Se, and Te. Exemplary metal chalcogenides include molybdenum disulfide (MoS₂) and molybdenum trioxide (MoO₃). Further layered materials that may be used in the present invention are disclosed in V. Nicolosi et al., Science, 340 (2013), 1420.

The fluid may be selected from any suitable solvent or polymer. Solvents with a surface tension which is close to that of the exfoliated material have been determined to be most likely to give the best exfoliation and dispersion performance. For example, for graphene dispersion, the best solvents may have a surface tension from about 30 to about 50 mJ m⁻². Surface tension may be determined using a tensiometer as set out in ASTM Standard D1331-14. For example, surface tension may be determined using du Noüy ring (platinum wire ring) methods or Wilhelmy plate (flat, thin plate made of glass or platinum) methods

The fluid may be an organic solvent, for example N-methyl pyrrolidone (NMP), cyclohexylpyrrolidone, di-methyl formamide, cyclopentanone (CPO), cyclohexanone, N-formyl piperidine (NFP), vinyl pyrrolidone (NVP), 1,3-dimethyl-2-imidazolidinone (DMEU), bromobenzene, benzonitrile, N-methyl-pyrrolidone (NMP), benzyl benzoate, N,N′-dimethylpropylene urea, (DMPU), gamma-butrylactone (GBL), dimethylformamide (DMF), N-ethyl-pyrrolidone (NEP), dimethylacetamide (DMA), cyclohexylpyrrolidone (CHP), dimethyl sulfoxide (DMSO), dibenzyl ether, chloroform, isopropylalcohol (IPA), cholobenzene, l-octyl-2-pyrrolidone (N8P), 1-3 dioxolane, ethyl acetate, quinoline, benzaldehyde, ethanolamine, diethyl phthalate, N-dodecyl-2-pyrrolidone (N12P), pyridine, dimethyl phthalate, formamide, vinyl acetate or acetone or a combination thereof.

The fluid may further comprise a polymer, for example selected from polyvinyl alcohol (PVA), polybutadiene (PBD), poly(styrene-co-butadiene) (PBS), polystyrene (PS), polyvinylchloride (PVC), polyvinylacetate (PVAc), polycarbonate (PC), polymethylmethacrylate (PMMA), polyvinylidene chloride (PVDC) and cellulose acetate (CA).

The fluid may further comprise a surfactant, for example selected from the group comprising sodium cholate (NaC), sodium dodecylsulphate (SDS), sodium dodecylbenzenesulphonate (SDBS), lithium dodecyl sulphate (LDS), sodium cholate (SC), sodium deoxycholate (DOC), sodium taurodeoxycholate (TDOC), polyoxyethylene (40) nonylphenyl ether, branched (IGEPAL CO-890® (IGP)), polyethylene glycol p-(1,1,3,3-tetramethylbutyl)-phenyl ether (Triton-X 100® (TX-100)), cetyltrimethyl ammoniumbromide (CTAB), tetradecyltrimethylammonium bromide (TTAB), Tween™ 20 and Tween™ 80. Further surfactants that may be used in the present invention are disclosed in R. J. Smith et al., New Journal of Physics 12 (2010) 125008.

Exfoliated graphene or exfoliated boron nitride nanosheets produced by a process of the present invention, for example, may be used for the mechanical reinforcement of polymers, to reduce the permeability of polymers, to enhance the conductivity (electrical and thermal) of polymers, and to produce transparent conductors and electrode materials.

The layered material may therefore be directly exfoliated into a matrix material such as a polymer. Accordingly, the fluid may therefore be a suitable matrix material such as a printable ink composition or a polymer or copolymer, for example selected from a thermoplastic, a thermoset, an elastomer or a biopolymer or a combination thereof.

As used herein, printable ink compositions are composition suitable for use as a printing ink and include inks suitable for use in 3D printing techniques.

The term “polymer” refers to a compound composed of repeating units, or a salt thereof. These units are typically connected by covalent chemical bonds. A polymer preferably comprises at least 10, at least 20, at least 50, at least 100 units or at least 200 units. A polymer may be terminated by any group, for example hydrogen. A polymer may be a homopolymer or a copolymer. Although the term “polymer” is sometimes taken to refer to plastics, it actually encompasses a large class comprising both natural and synthetic materials with a wide variety of properties. Such polymers may be thermoplastics, elastomers, or biopolymers.

The term “copolymer” should be understood to mean a polymer derived from two (or more) monomeric species, for example a combination of any two of the below-mentioned polymers. An example of a copolymer, but not limited to such, is PETG (polyethylene terephthalate glycol), which is a PET modified by copolymerization. PETG is a clear amorphous thermoplastic that can be injection moulded or sheet extruded and has superior barrier performance used in the container industry. The term “thermoset” should be understood to mean materials that are made by polymers joined together by chemical bonds, acquiring a highly cross-linked polymer structure. The highly cross-linked structure produced by chemical bonds in thermoset materials is directly responsible for the high mechanical and physical strength when compared with thermoplastics or elastomers materials.

The polymer may be a thermoplastic which may be selected from, but not limited to, the group comprising acrylonitrile butadiene styrene, polypropylene, polyethylene, polyvinylchloride, polyamide, polyester, acrylic, polyacrylic, polyacrylonitrile, polycarbonate, ethylene-vinyl acetate, ethylene vinyl alcohol, polytetrafluoroethylene, ethylene ch lorotrifluoroethylene, ethylene tetrafluoroethylene, liquid crystal polymer, polybutadiene, polychlorotrifluoroethylene, polystyrene, polyurethane, and polyvinyl acetate.

The polymer may be a thermoset which may be selected from, but not limited to, the group comprising vulcanised rubber, Bakelite™ (polyoxybenzylmethylenglycolanhydride), urea-formaldehyde foam, melamine resin, polyester resin, epoxy resin, polyimides, cyanate esters or polycyanurates, silicone, and the like known to the skilled person.

The polymer may be an elastomer which may be selected from, but not limited to, the group comprising polybutadiene, butadiene and acrylonitrile copolymers (NBR), natural and synthetic rubber, polyesteramide, chloropene rubbers, poly(styrene-b-butadiene) copolymers, polysiloxanes (such as Polydimethylsiloxane (PDMS)), polyisoprene, polyurethane, polychloroprene, chlorinated polyethylene, polyester/ether urethane, poly ethylene propylene, chlorosulfanated polyethylene, polyalkylene oxide and mixtures thereof.

The polymer may be a biopolymer which may be selected from, but not limited to, the group comprising gelatin, lignin, cellulose, polyalkylene esters, polyvinyl alcohol, polyamide esters, polyalkylene esters, polyanhydrides, polylactide (PLA) and its copolymers and polyhydroxyalkanoate (PHA).

The polymer may be a copolymer selected from, but not limited to, the group comprising copolymers of propylene and ethylene, acetal copolymers (polyoxymethylenes), polymethylpentene copolymer (PMP), amorphous copolyester (PETG), acrylic and acrylate copolymers, polycarbonate (PC) copolymer, styrene block copolymers (SBCs) to include poly(styrene-butadiene-styrene) (SBS) , poly(styrene-isoprene-styrene) (SIS), poly(styrene-ethylene/butylene-styrene) (SEBS), ethylene vinyl acetate (EVA) and ethylene vinyl alcohol copolymer (EVOH) amongst others.

Apparatus Residence Time

The shear experienced by the layered material to be exfoliated is primarily governed by the parameters described above. The time a particle stays within the apparatus, under the influence of this shear/mixing, is controlled by the external pump flow rate, \dot{Q}. For example, particles of a layered material introduced into the apparatus can be kept there indefinitely by setting the pump flow rate to zero. Conversely, short residence times can be achieved by setting high flow rates.

The housing of the apparatus of the invention may be cylindrical such that the housing and the rotor may be arranged as concentric cylinders. Alternatively, the housing may have a conical shape.

As used herein, a cylinder or a cylindrical object, is a 3-dimensional geometric object having two ends and a constant circular cross section (i.e., which is the same from one end to the other) with a curved side wall provided between the two ends.

As used herein, a cone or conical object, is a 3-dimensional object having a circular cross-section and two ends and a curved side wall, where the radius of the cross-section is largest at one end and decreases to the other end such that, at the other end, the curved wall ends in an apex point. Thus, the other end is an apex. A cone is preferably a right cone, where the apex is aligned directly above the center of the cross-section of the cone. A cone or conical, as used herein includes a frustum of a cone, where the apex has been cut-off to leave a circular other end.

The housing may comprise a first end and a second end, with the housing wall provided therebetween, arranged in the same orientation as the first and second end of the rotor. The apparatus may further comprise a base at the second end of the housing. As would be appreciated by a skilled person, during operation of the apparatus, the apparatus is sealed at the second end of the housing. The seal at the second end of the housing may form part of the housing.

In the apparatus of the invention, the fluid flow path between the inner and outer chambers may be provided at the first end of the rotor, which during operation of the apparatus is towards the top of the apparatus. The fluid inlet and outlets to the apparatus into the inner and outer chambers may be located at the second end of the rotor, which during operation of the apparatus is below the fluid flow path. Thus, during operation of the apparatus, both the inflow and outflow of the fluid are positioned towards the bottom of the apparatus. Where, for example, the fluid inlet is in fluid communication with the inner chamber, this configuration delivers the unexfoliated layered material to the inside of the rotor and against gravity. This advantageously eliminates layered material particle build-up that could lead to a flow blockage. Both the inlet and outlet are provided at the second end of the rotor, i.e., below the fluid flow path, thus, the flow directions can be easily reversed so the fluid is introduced into the device through inlet into the outer chamber against gravity. This makes it robust to different mixing/shearing needs of the user.

Embodiments are now described by way of non-limiting example to illustrate aspects and principles of the disclosure, with reference to the accompanying drawings.

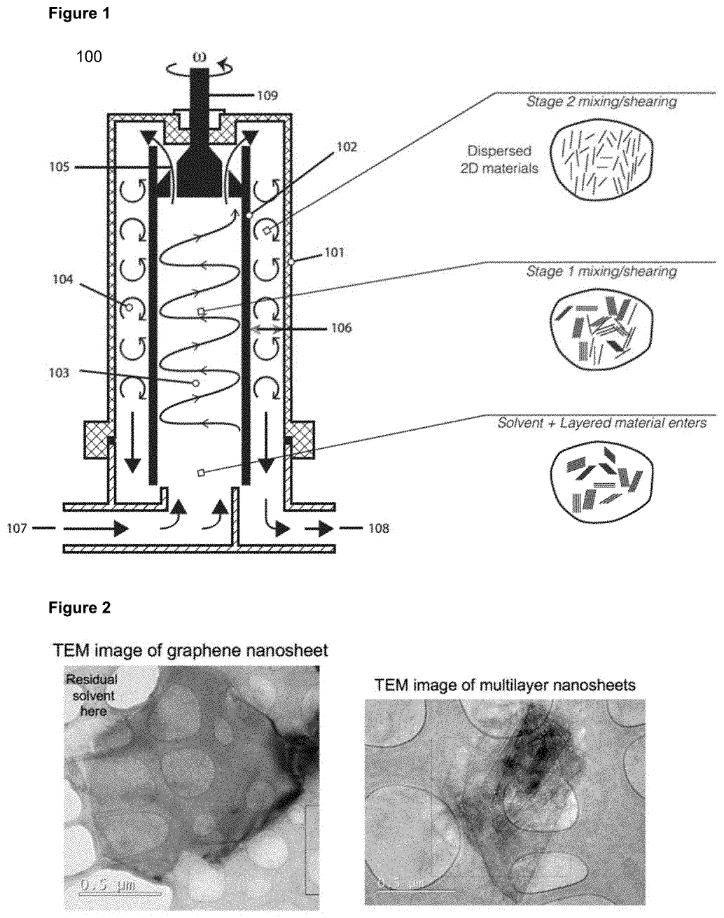

With reference to FIG. 1, there is provided an apparatus 100 for the continuous exfoliation of a layered material. The apparatus comprises a housing 101 of circular cross-section, a rotor of circular cross-section 102 arranged concentrically within the housing. The rotor defines an inner chamber 103 and the space between the rotor and the housing defines an outer chamber 104. A fluid flow path 105 is provided between the inner chamber and the outer chamber. The apparatus also comprises a fluid inlet 107 in fluid communication with the inner chamber and a fluid outlet 108 in fluid communication with the outer chamber. The outer chamber has a width 106 of about 3 mm. The apparatus further comprises a motor and shaft 109 configured to rotate the rotor.

The following steps outline an exemplary process for exfoliating a layered material using an apparatus as shown in FIG. 1:
1. Flakes of a layered material (graphite, Sigma-Aldrich® 332461) having average lateral dimension of about 150 μm and organic solvent (N-Methyl-2-Pyrrolidone, VWR 26211.425) was placed in a reservoir (80 mL) at a fixed concentration (50 g/L).
2. A peristaltic pump, located between the reservoir and the apparatus inlet, was initially run at a low pump flow rate (10 mL min⁻¹). This slowly moved the fluid into the apparatus for bleeding of the system.
3. At this flow rate, air was removed from within the apparatus, to ensure the entire fluid loop was without trapped air during the exfoliation operation.
4. Once this was completed, the motor connected to the rotor was switched on and rotated at speed that resulted in exfoliation (8000 r.p.m.)
5. Maintaining a constant rotor rotational speed, the fluid was circulated from the reservoir to the device using the peristaltic pump (20 mins at 50 mL min⁻¹).
6. The exfoliated fluid was then removed from the reservoir and any remaining layered material was allowed to sediment (sedimentation conditions were 24 hrs at 1 g)
7. Mono- and few-layer material (graphene) was decanted and tested with Transmission Electron Microscopy to examine the characteristics of the 2d materials produced. FIG. 2 shows Transmission Electron Microscopy images of the graphene product. FIG. 2, top image shows graphene mono-layers with a sheet length of approximately 1-2 μm, supported on a holey carbon grid. The bottom image shows graphene multi-layer sheets with a sheet length of approximately 1-2 μm, supported on a holey carbon grid. The shear rate was determined to be γ˜1×10⁴ s⁻¹, Re=1.8×10⁴, and Ta=1.49×10⁸).

It will be appreciated that the values in the above example will change depending on the scale of the apparatus for production and production requirements.

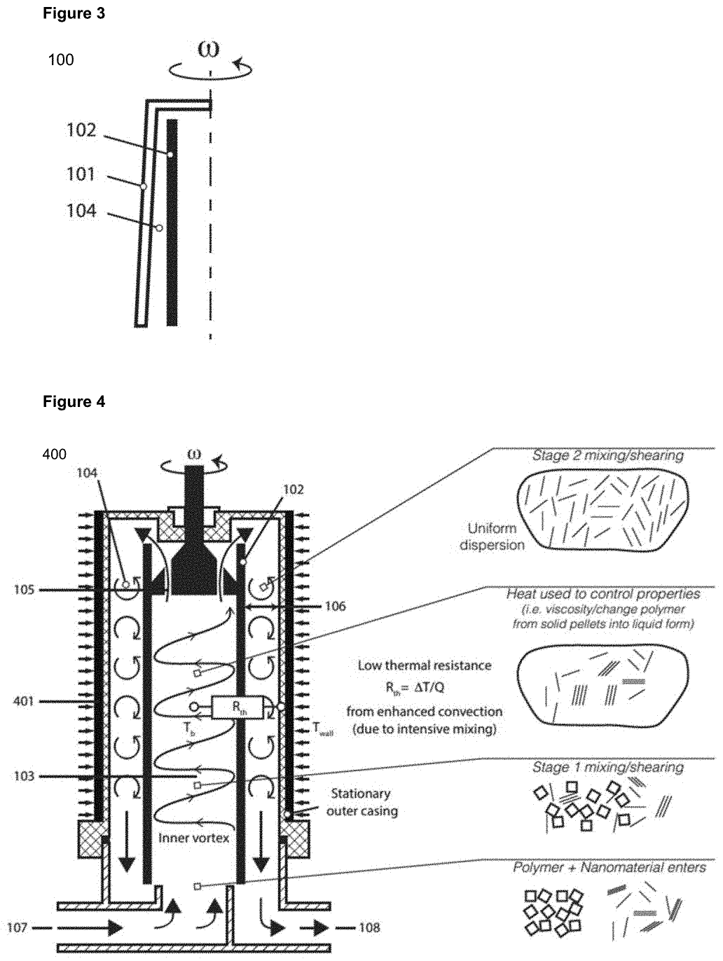

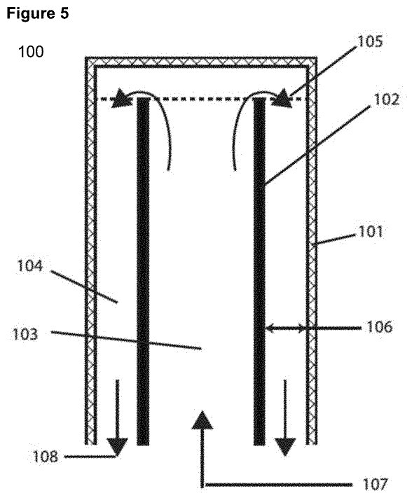

With reference to FIG. 3, there is provided apparatus 100, wherein the housing has a conical shape and the rotor has cylindrical shape creating a tapered outer chamber where the width of the outer chamber is smaller at the top of the device near the fluid flow path than at the bottom of the device near the fluid outlet.

With reference to FIG. 4, there is provided an apparatus 400 for the continuous exfoliation of a layered material. This embodiment demonstrates the homogeneous heat transport capability of the inventive apparatus. Situations can occur where material heating or cooling is necessary during production. For example, this invention can enable the direct exfoliation and dispersion of 2D materials (and other 0D/1D materials) into a matrix material, for example a polymer. This has unique benefits, including the removal of complex processing steps currently involved in composite production. Surface heating/cooling is imposed on the housing. This can be introduced using flexible heater mats 401 (i.e. for heating only), or an outer heating/cooling jacket 301, which circulates hot/cold coolant. The millimetre-scale outer chamber 106 (˜3mm), in combination with the numerous vortices outside and inside the rotating rotor 102 during operation, provides a low convective-diffusive thermal resistance between the heat source and the product. A basic estimate of the thermal resistance, Rₜₕ, is ˜0.06 K/W by extending heat transport correlations in the literature to this invention (and assuming a Prandtl number of 10) (see S. Seghir-Ouali et al., Int. J. Thermal Sciences, 45 (2006), 1166-1178 and S. Poncet et al., Int. J. Heat Fluid Flow, 32 (2010), 128-144, the contents of which are herein incorporated by reference in their entirety). This low value of thermal resistance demonstrates that near homogeneous heating/cooling of the product will occur. This invention also exfoliates and disperses small volumes (˜100 mL) in a continuous manner. The heat capacity of the exfoliator at zero mass flow rate is, therefore, also small. Rapid heating and cooling of the product is enabled, intensifying the exfoliation and dispersion characteristics by adjusting the thermophysical properties (i.e. viscosity) and/or processing solid polymer granules/pellets through a change of phase.

Throughout the description and claims of this specification, the words “comprise” and “contain” and variations of the words, for example “comprising” and “comprises”, mean “including but not limited to”, and are not intended to (and do not) exclude other components.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

Reference is now made to the following examples, which illustrate the invention in a non-limiting fashion.

### EXAMPLES

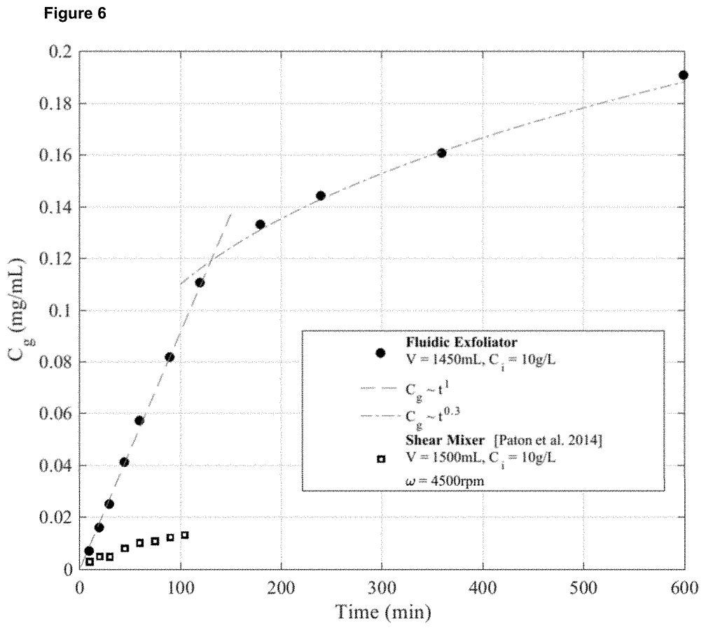

FIG. 6 presents graphene concentration over a processing time of 10 hours for the invention. This exfoliation performance was achieved in a device as illustrated in FIG. 1 at a moderate cylindrical rotor operating speed of 1333 rpm, cylindrical rotor diameter of 101 mm, cylindrical rotor height of 100 mm, outer chamber width of 2 mm, and pump flow rate of 320 ml/min. This resulted in a rotational Reynolds number of 9500. This corresponds to the Taylor vortex regime.

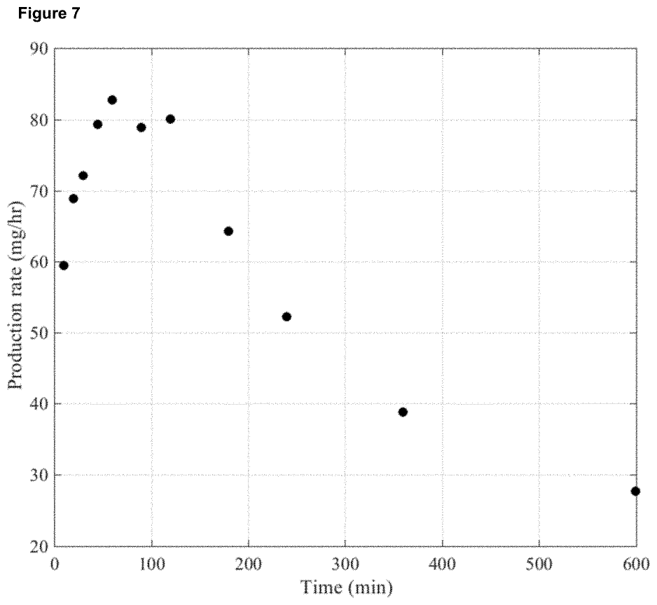

As a comparison, the performance of the device was compared to that of the Shear Mixing approach presented by Paton et al., Nature Materials, 13 (2014), 624-630, the contents of which are herein incorporated by reference in their entirety. In both cases, the starting graphite (Sigma Aldrich® product no. 332461), solvent (NMP), and graphite concentration (10 g/L) were identical. The volume used in both processes was also closely matched at around 1.5 L. The invention is shown to outperform the Shear Mixing approach by a factor of 7. The concentration data is replotted in terms of production rate in FIG. 7, suggesting a processing time of 2 hours may provide the optimum to scale-up material output.

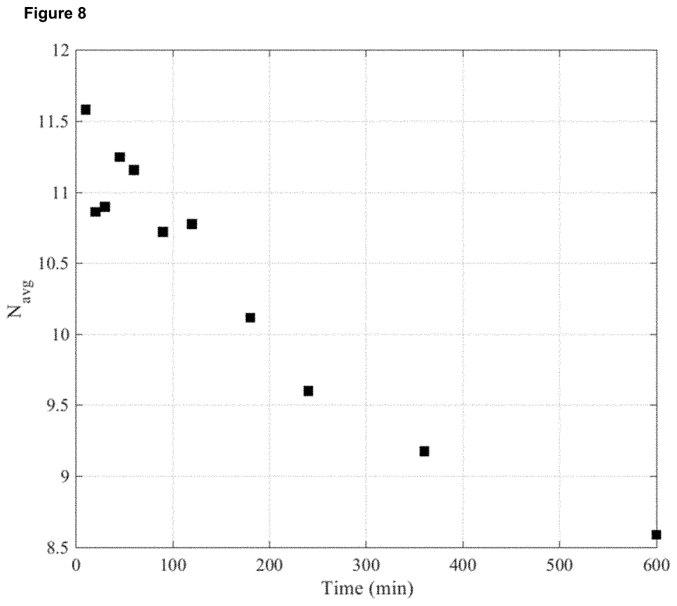

FIG. 8 presents the average number of layers over time for the graphene produced in FIG. 6. This has been determined through UV-Vis-nIR measurement and the spectroscopic method described by Backes et al., Nanoscale, 8 (2016), 4311-4323, the contents of which are herein incorporated by reference in their entirety. The number of layers decreases with processing time from ˜11.5 to ˜8.5. The invention can, therefore, be operated to selectively achieve a required average layer number.

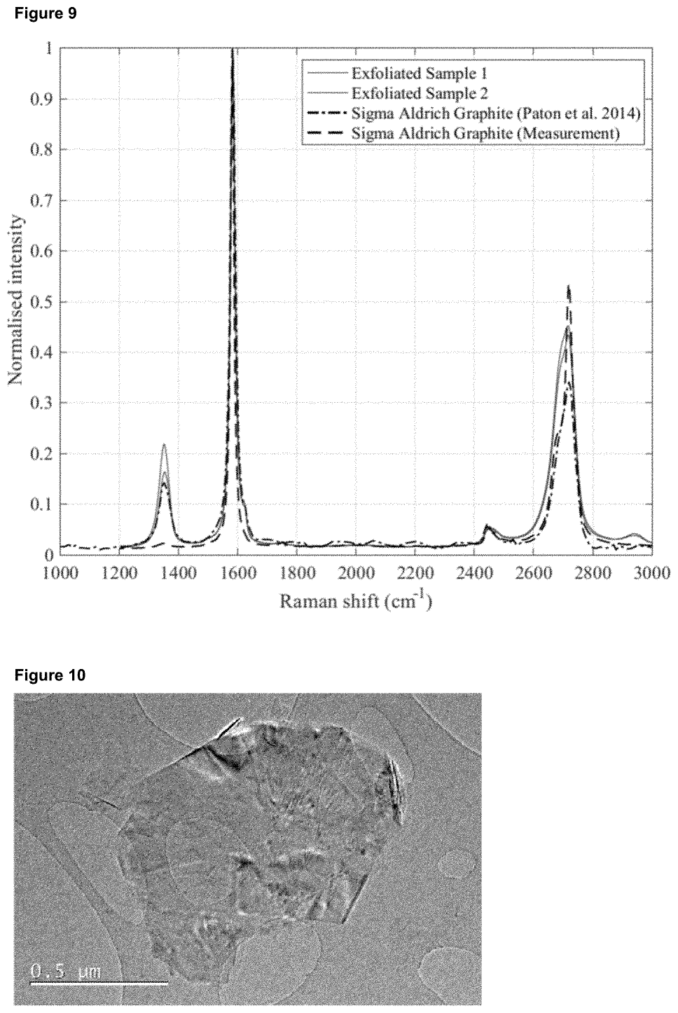

FIG. 9 provides the Raman shift for the fluid exfoliated graphene product. This has been acquired through vacuum filtering the dispersed graphene nanosheets onto a PTFE membrane with ˜250nm thick layer. The Raman data for different sampling points demonstrate the characteristics of few-layer graphene (2D band), reinforcing the UV-Vis-nIR findings. The graphite precursor is shown also, indicating that it can also have a D band ˜0.15, close to that of the graphene produced. This suggests that the product is defect-free (basal-plane defects). The increase to the D band (0.17-0.25) for the exfoliated product is predominantly due to the nanosheet edge contributions (Paton et al., Nature Materials, 13 (2014), 624-630), and the graphene is of high quality.

Finally, a typical graphene nanosheet produced from the invention is shown in FIG. 10 and obtained using Transmission Electron Microscopy (TEM). From TEM observations, it was found that the graphene produced may range in length between 100 nm and 10 microns.

While preferred embodiments of the present invention have been shown and described herein, it will be apparent to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention and that methods and structures within the scope of these claims and their equivalents be covered thereby.

1. An apparatus for fluidic exfoliation of a layered material comprising:
a housing of circular cross-section defined by a housing wall;
a hollow rotor of circular cross-section having a first end and a second end and a wall positioned therebetween arranged concentrically within the housing, wherein the wall of the hollow rotor defines an inner chamber and the-a space between the wall of the hollow rotor and the housing wall defines an outer chamber, and wherein a fluid flow path is provided between the inner chamber and the outer chamber;
a fluid inlet in fluid communication with the inner chamber or the outer chamber; and
a fluid outlet in fluid communication with the other of the inner chamber or the outer chamber;
wherein the outer chamber has a width such that on passage of a fluid comprising the layered material from the inlet to the outlet through the outer chamber, a shear rate sufficient to exfoliate the layered material may be applied to the fluid comprising the layered material in the outer chamber by rotation of the hollow rotor.

2. The apparatus of claim 1, wherein the housing is in a fixed position; and/or wherein the outer chamber has a constant width throughout the apparatus.

3. (canceled)

4. The apparatus of claim 1, wherein the outer chamber has a width not exceeding about 1 cm.

5. The apparatus of claim 1, wherein the rotor is cylindrical; and/or wherein the housing wall is cylindrical.

6. (canceled)

7. The apparatus of claim 1, further comprising a pump arranged to drive the fluid comprising the layered material through the apparatus.

8. The apparatus of claim 1, further comprising a fluid reservoir in fluid communication with the fluid inlet for holding the fluid comprising the layered material.

9. The apparatus of claim 1, further comprising a motor configured to provide a rotational force to rotate the rotor.

10. The apparatus of claim 1, further comprising a source of heat to heat the fluid comprising the layered material passing through the apparatus.

11. The apparatus of claim 1, wherein the layered material is graphite, BN, GaTe, Bi₂Se₃, Bi₂Te₃, Sb₂Te₃, TiNC1, black phosphorus, layered silicate, layered double hydroxide or a transition metal chalcogenide having the formula MXₙ, wherein M is a transition metal selected from the group comprising Ti, Zr, Hf, V, Nb, Ta, Cr, Mn, Mo, W, Tc, Re, Ni, Pd, Pt, Fe and Ru, X is a chalcogen selected from the group comprising O, S, Se, and Te; and n is 1 to 3, or a combination thereof.

12. (canceled)

13. (canceled)

14. (canceled)

15. (canceled)

16. A process for fluidic exfoliation of a layered material using an apparatus as claimed in claim 1, comprising:
introducing the fluid comprising the layered material through the fluid inlet; and
applying a shear rate to the layered material by rotating the rotor at a speed sufficient to exfoliate the layered material.

17. A process for fluidic exfoliation of a layered material using an apparatus as claimed in claim 1, comprising:
introducing the fluid comprising the layered material through the fluid inlet;
passing the fluid into the inner chamber;
passing the fluid through the fluid flow path to the outer chamber;
passing the fluid from the outer chamber to the fluid outlet;
wherein the rotor is rotating at a speed sufficient to apply a shear rate to exfoliate the layered material.

18. A process for fluidic exfoliation of a layered material using an apparatus as claimed in claim 1, comprising:
introducing the fluid comprising the layered material through the fluid inlet;
passing the fluid into the outer chamber;
passing the fluid from the outer chamber through the fluid flow path to the inner chamber;
passing the fluid from the inner chamber to the fluid outlet;
wherein the rotor is rotating at a speed sufficient to apply a shear rate to exfoliate the layered material.

19. The process of claim 16, wherein the process is a continuous process.

20. (canceled)

21. (canceled)

22. The process of claim 16, wherein the shear rate applied is greater than about 1000 s⁻¹.

23. The process of claim 16, further comprising heating the fluid comprising the layered material while the fluid is in the apparatus and/or prior to introducing the fluid into the apparatus.

24. The process of claim 16, wherein the fluid comprises particles of the layered material; and/or wherein the fluid comprises about 0.1 to about 15 wt % of the layered material calculated as a total weight of the fluid and layered material.

25. (canceled)

26. The process of claim 16, wherein the layered material is graphite, BN, GaTe, Bi₂Se₃, Bi₂Te₃, Sb₂Te₃, TiNC1, black phosphorus, layered silicate, layered double hydroxide (such as Mg₆Al₂(OH)₁₆) or a transition metal chalcogenide having the formula MXₙ, wherein M is a transition metal selected from the group comprising Ti, Zr, Hf, V, Nb, Ta, Cr, Mn, Mo, W, Tc, Re, Ni, Pd, Pt, Fe and Ru, X is a chalcogen selected from the group comprising O, S, Se, and Te and n is 1 to 3, or a combination thereof.

27. (canceled)

28. (canceled)

29. The process of claim 16, wherein the fluid comprises an organic solvent, for example selected from the group consisting of N-methyl pyrrolidone (NMP), cyclohexylpyrrolidone, di-methyl formamide, cyclopentanone (CPO), cyclohexanone, N-formyl piperidine (NFP), vinyl pyrrolidone (NVP), 1,3-dimethyl-2-imidazolidinone (DMEU), bromobenzene, benzonitrile, N-methyl-pyrrolidone (NMP), benzyl benzoate, N,N′-dimethylpropylene urea, (DMPU), gamma-butrylactone (GBL), Dimethylformamide (DMF), N-ethyl-pyrrolidone (NEP), dimethylacetamide (DMA), cyclohexylpyrrolidone (CHP), dimethyl sulfoxide (DMSO), dibenzyl ether, chloroform, isopropylalcohol (IPA), cholobenzene, l-octyl-2-pyrrolidone (N8P), 1-3 dioxolane, ethyl acetate, quinoline, benzaldehyde, ethanolamine, diethyl phthalate, N-dodecyl-2-pyrrolidone (N12P), pyridine, dimethyl phthalate, formamide, vinyl acetate and acetone or a combination thereof.

30. The process of claim 16, wherein the fluid further comprises:
a polymer selected from polyvinyl alcohol (PVA), polybutadiene (PBD), poly(styrene-co-butadiene) (PBS), polystyrene (PS), polyvinylchloride (PVC), polyvinylacetate (PVAc), polycarbonate (PC), polymethylmethacrylate (PMMA), polyvinylidene chloride (PVDC) and cellulose acetate (CA); and/or
a surfactant selected from the group comprising consisting of sodium cholate (NaC), sodium dodecylsulphate (SDS), sodium dodecylbenzenesulphonate (SDBS), lithium dodecyl sulphate (LDS), sodium cholate (SC), sodium deoxycholate (DOC), sodium taurodeoxycholate (TDOC), polyoxyethylene (40) nonylphenyl ether, branched (IGEPAL CO-890® (IGP)), polyethylene glycol p-(1,1,3,3-tetramethylbutyl)-phenyl ether (Triton-X 100® (TX-100)), cetyltrimethyl ammoniumbromide (CTAB), tetradecyltrimethylammonium bromide (TTAB), Tween™ 20 and Tween™ 80.

31. The process of claim 16, wherein the fluid is a printable ink composition or a polymer or copolymer selected from a thermoplastic, a thermoset, an elastomer and a biopolymer or a combination thereof.

32. The process of claim 16, wherein the exfoliated layered material is removed from the fluid, optionally by low-speed centrifugation, gravity settling, filtration or flow separation.

33. The process of claim 32, further comprising the step of placing the exfoliated layered material into a matrix to form a composite.

34. (canceled)

35. (canceled)
